(19) United States
(12) Patent Application Publication
(10) Pub. No.: US 2012/0148178 A1
(43) Pub. Date: Jun. 14, 2012

(54) Leakproof Structure of Shaft Tube

(76) Inventor: Alex Horng, Kaohsiung (TW)

(21) Appl. No.: 13/396,822

(22) Filed: Feb. 15, 2012

Related U.S. Application Data
(62) Division of application No. 12/253,361, filed on Oct. 17, 2008.

(30) Foreign Application Priority Data
Sep. 23, 2008 (TW) 97136466

(51) Int. Cl. F16C 33/74

(52) U.S. Cl. 384/130

(57) ABSTRACT

A leakproof structure of a shaft tube comprises a shaft tube, a bearing, a shaft and a leakproof plate. The shaft tube includes a center hole, an upper section adjacent to an open end of the shaft tube and a lower section having an inner diameter smaller than that of the upper section. The bearing received in the lower section includes a longitudinal hole. The shaft rotatably mounted into the bearing includes an annular groove formed in an outer periphery thereof to form a neck of the shaft. The leakproof plate fixed in the upper section includes a through-hole with a diameter smaller than the outer diameters of the two sections of the shaft, with an inner edge of the leakproof plate being in the annular groove.

This is a divisional application of U.S. patent application Ser. No. 12/253,361 filed on Oct. 17, 2008.

### FIELD OF THE PRESENT INVENTION

The present invention relates to leakproof structure, and more particularly, to a leakproof structure of a shaft tube that can avoid oil leakage.

### BACKGROUND OF THE INVENTION

Referring to FIG. 1, a conventional motor includes a shaft tube 91 receiving a bearing 92 with a longitudinal hole 921 centrally passing through the bearing 92, and a shaft 93. One end of the shaft 93 is fixed to a rotor of the motor and the other end of the shaft 93 rotatably extends through the longitudinal hole 921 of the bearing 92. An annular gasket 94 is disposed on a top of the bearing 92 for preventing the shaft tube 91 from leaking oil therein. Further, there is a retainer ring 95 mounted around the shaft 93 and close to the end of the shaft 93 extending through the longitudinal hole 921 to prevent the shaft 93 from disengaging from the bearing 92.

However, when the shaft 93 rotates in the longitudinal hole 921 of the bearing 92, a temperature of the oil is raised, that leads to decrease of viscosity of the oil, because of friction between the shaft 93 and the bearing 92. Thus, the oil easily leaks out of the shaft tube 91. Although the annular gasket 94 is disposed on the top of the bearing 92 to prevent the oil from leaking out, the oil still can leak out through gaps between the bearing 92 and the shaft 93 and gaps between the bearing 92 and the shaft tube 91.

Furthermore, gaps between the annular gasket 94 and the shaft tube 91 connect to gaps between the bearing 92 and the shaft tube 91, and hence the annular gasket 94 can't not prevent the oil from leaking out of the shaft tube 91 but merely extends the time of the oil leaking out of the shaft tube 91 when the oil passes through the gaps between the bearing 92 and the shaft tube 91 to the annular gasket 94. Plus, for preventing the shaft 93 from disengaging from the bearing 92, the retainer ring 95 is indispensable, and that results in a complex structure for assembly.

### SUMMARY OF THE INVENTION

It is therefore the primary objective of this invention to provide a leakproof structure of a shaft tube that overcomes the problems of the prior art described above to prevent the shaft tube from leaking oil therein.

The secondary objective of this invention is to provide the leakproof structure of a shaft tube that can prevent a shaft from disengaging from a bearing.

The third objective of this invention is to provide the leakproof structure of a shaft tube that allows a simplified structure for assembly.

A leakproof structure of a shaft tube according to the preferred teachings of the present invention includes a shaft tube, a bearing, a shaft and a leakproof plate. The shaft tube includes a center hole with two ends thereof open and closed respectively, an upper section adjacent to the open end of the center hole and a lower section having an inner diameter smaller than that of the upper section. The bearing is received in the lower section of the shaft tube and includes a longitudinal hole extending along a longitudinal axis of the bearing. The shaft includes an annular groove in a neck shape formed in an outer periphery of the shaft to form a neck of the shaft, with one end of the shaft extending through the longitudinal hole of the bearing and the annular groove being adjacent to the other end of the shaft. The neck of the shaft has an outer diameter smaller than that of two sections of the shaft, with said two sections being adjacent to two end edges of the annular groove. The leakproof plate is fixed in the upper section of the shaft tube and includes a through-hole with a diameter smaller than the outer diameters of the two sections of the shaft, with an inner edge of the leakproof plate being in the annular groove.

The leakproof plate directly covers ends of undesired gaps between the bearing and the shaft tube, with said ends of the gaps being close to the open end of the center hole of the shaft tube. Accordingly, by arrangement of the leakproof plate, leaking paths of oil inside the shaft tube is blocked to prevent leakage of the oil.

The inner edge of the leakproof plate is in the annular groove of the shaft. Accordingly, the oil is prevented from leaking out via gaps between the bearing and the shaft, and the shaft disengaging from the bearing is also prevented.

The leakproof plate is able to not only avoid the leakage of the oil but also to retain the shaft to omit a retainer ring that is mounted around a shaft and close to an end of the shaft extending through a bearing. Accordingly, a simplified structure for assembly is provided.

Further scope of the applicability of the present invention will become apparent from the detailed description given hereinafter. However, it should be understood that the detailed description and specific examples, while indicating preferable embodiments of the invention, are given by way of illustration only, since various modifications will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a cross sectional view illustrating a conventional leakproof structure of a shaft tube;

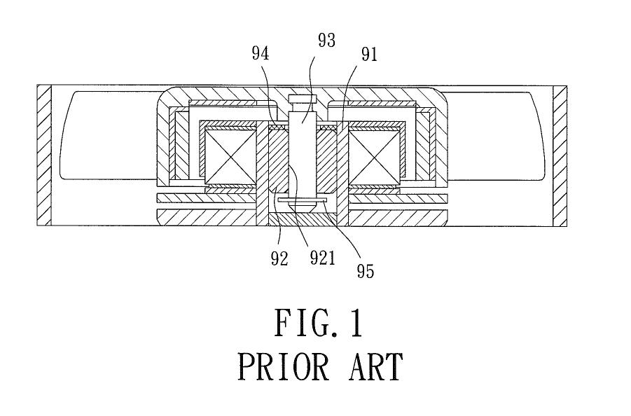

FIG. 2 is an exploded perspective view illustrating a leakproof structure of a shaft tube in accordance with a first embodiment of the present invention;

FIG. 3 is a cross sectional view illustrating the leakproof structure of a shaft tube in accordance with the first embodiment of the present invention;

FIG. 4 is a cross sectional view illustrating a leakproof structure of a shaft tube in accordance with a second embodiment of the present invention; and

FIG. 5 is a cross sectional view illustrating a leakproof structure of a shaft tube in accordance with a third embodiment of the present invention.

In the various figures of the drawings, the same numerals designate the same or similar parts. Furthermore, when the terms “upper”, “lower”, “section”, “annular”, “end”, “outwards”, “upwards”, “inner”, “outer” and similar terms are used hereinafter, it should be understood that these terms are reference only to the structure shown in the drawings as it would appear to a person viewing the drawings and are utilized only to facilitate describing the invention.

### DETAILED DESCRIPTION OF THE INVENTION

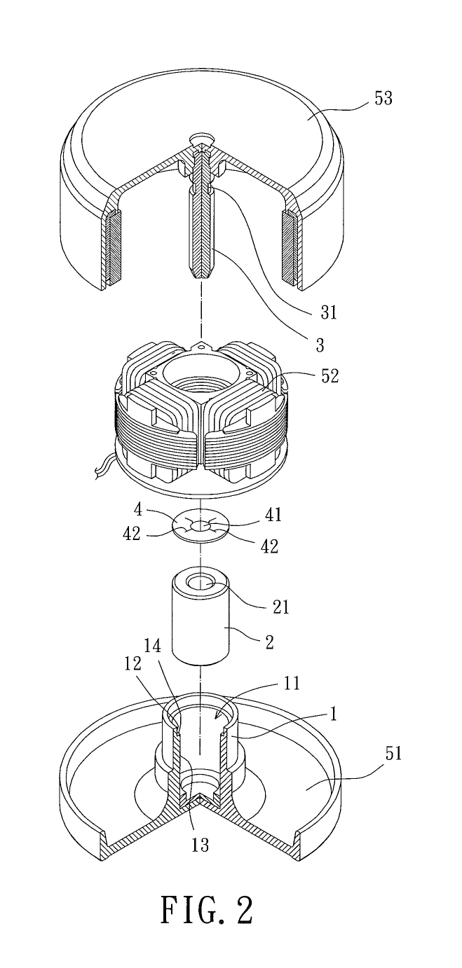

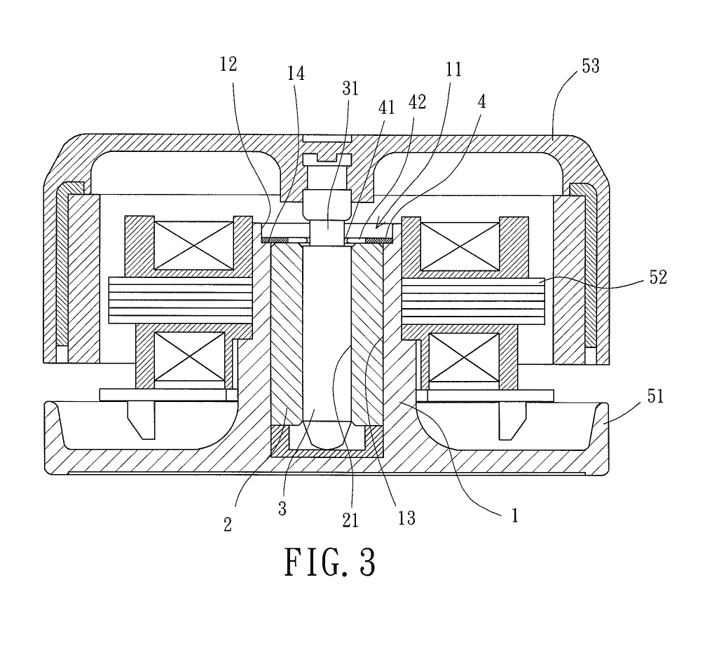

A leakproof structure of shaft tube of a first embodiment according to the preferred teachings of the present invention is shown in FIGS. 2 and 3 of the drawings. According to the first embodiment form shown, the leakproof structure of shaft tube includes a shaft tube 1, a bearing 2, a shaft 3 and a leakproof plate 4.

The shaft tube 1 is disposed on a base 51 where a stator 52 is mounted. The shaft tube 1 and the base 51 can be formed into a single piece or two separate components that are combined with each other (not illustrated). The shaft tube 1 has a center hole 11, with one end of the center hole 11 being sealed by the base 51 and the other end of the center hole 11 being open to mount the bearing 2 and the leakproof plate 4. The shaft tube 1 includes an upper section 12 adjacent to the open end of the center hole 11 and a lower section 13 having an inner diameter smaller than that of the upper section 12, such that a shoulder 14 in an inner periphery of the center hole 11 and between the upper section 12 and the lower section 13 is formed.

The bearing 2 is preferably selected from a sleeve bearing and has a longitudinal hole 21 extending along a longitudinal axis thereof

One end of the shaft 3 is coupled to a rotor 53 and the other end of the shaft 3 rotatably extends through the longitudinal hole 21 of the bearing 2. An annular groove 31 in a neck shape is formed in an outer periphery of the shaft 3, close to the end where the shaft 3 is coupled to the rotor 53, and forming a neck of the shaft 3. In addition, the neck of the shaft 3 has an outer diameter smaller than that of two sections of the shaft 3, with said two sections being adjacent to two end edges of the annular groove 31.

The leakproof plate 4 made of flexible material has a through-hole 41 with a diameter smaller than the outer diameters of the two sections of the shaft 3 but larger than the outer diameter of the neck of the shaft 3. Moreover, the leakproof plate 4 preferably forms a plurality of slits 42 extending radially and outwards from an inner edge of the leakproof plate 4.

Referring again to FIGS. 2 and 3, in assembly, the bearing 2 is received in the lower section 13 of the shaft tube 1 through the center hole 11, with a position of the top of the bearing 2 being at the same level as or slightly lower than that of the shoulder 14. The leakproof plate 4 is received in the upper section 12 of the shaft tube 1, with the leakproof plate 4 abutting against the shoulder 14. Furthermore, the leakproof plate 4 is preferably fixed in the shaft tube 1 and coupled to the top of the bearing 2 with a close-fit, adhesive or other methods. When the shaft 3 is forcibly inserted through the through-hole 41 of the leakproof plate 4, the leakproof plate 4 flexibly deforms to expand the through-hole 41 by the slits 42. Therefore, the shaft 3 can easily pass through the through-hole 41 of the leakproof plate 4 to be rotatably received in the bearing 2 while the stator 52 is arranged inside and corresponding to the rotor 53. Besides, the leakproof plate 4 extends into the annular groove 31 of the shaft 3, with an inner edge of the leakproof plate 4 being in the annular groove 31 to retain the shaft 3, such that departure of the shaft 3 from the bearing 2 is avoided.

In use, the leakproof plate 4 of the present invention directly covers ends of undesired gaps between the bearing 2 and the shaft tube 1, with said ends of the gaps being close to the shoulder 14 of the shaft tube 1, to block paths through which the oil inside the shaft tube 1 leaks out. Hence, leakage of the oil inside the shaft tube 1 is prevented. In addition to avoiding departure of the shaft 3 from the bearing 2, the leakage of the oil through gaps between the bearing 2 and shaft 3 is also prevented effectively by the leakproof plate 4 extending into the annular groove 31 of the shaft 3. Further, a retainer ring that is mounted around a shaft and close to an end of the shaft extending through a bearing can be omitted. Thus a simplified structure for assembly is provided.

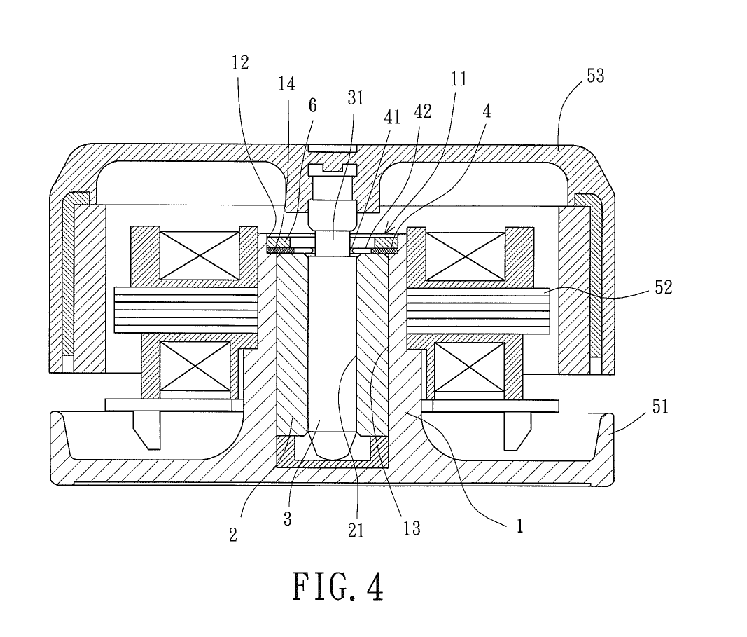

FIG. 4 shows a leakproof structure of a shaft tube of a second embodiment according to the preferred teachings of the present invention modified from the first embodiment. A positioning ring 6 is received in the upper section 12 of the shaft tube 1, with the positioning ring 6 abutting against the leakproof plate 4, so that the leakproof plate 4 is sandwiched and retained between the positioning ring 6 and the shoulder 14. The positioning ring 6 preferably has a rectangular cross-section and is fixed in the shaft tube 1 and coupled to the top of the bearing 2 with a close-fit, adhesive or other methods. Thus, the leakproof plate 4 disengaging from the shaft tube 1 is prevented and a more reliable combination of the leakproof plate 4 and the shaft tube 1 is provided, enhancing coupling stability.

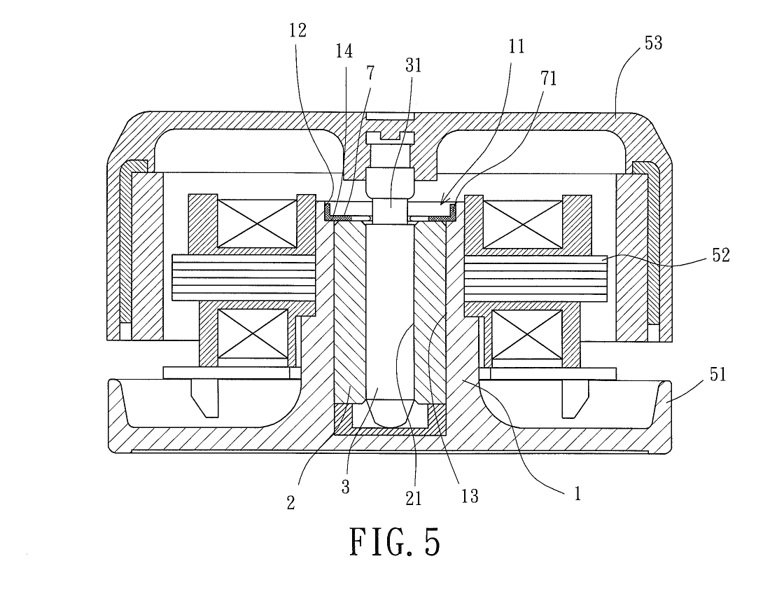

FIG. 5 shows a leakproof structure of a shaft tube of a third embodiment according to the preferred teachings of the present invention modified from the first embodiment. A leakproof plate 7 has a flange 71 formed on an outer edge thereof Furthermore, the flange 71 extends along the longitudinal axis of the bearing 2 and upwards to the open end of the center hole 11 of the shaft tube 1, with the flange 71 contacting with the inner periphery of the upper section 12 of the shaft tube 1 to increase a contact area between the inner periphery of the upper section 12 and the leakproof plate 7.

Thus, by arrangement of the flange 71 of the leakproof plate 7, coupling stability between the leakproof plate 7 and the shaft tube 1 is enhanced without any fixing component.

As has been discussed above, the leakproof plate 4, 7 directly covering the ends of the undesired gaps between the bearing 2 and the shaft tube 1 is able to block the paths through which the oil inside the shaft tube 1 leaks out, to avoid leakage of the oil. Moreover, by the leakproof plate 4, 7 extending into the annular groove 31 of the shaft 3, the leakage of the oil through the gaps between the bearing 2 and the shaft 3 is prevented effectively, and departure of the shaft 3 from the bearing 2 is avoided while a retainer ring is omitted to provide a simplified structure for assembly.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A leakproof structure of shaft tube, comprising:
a shaft tube including a center hole with two ends thereof open and sealed respectively, with the shaft tube further including an upper section adjacent to the open end of the center hole and a lower section having an inner diameter smaller than that of the upper section;
a bearing being received in the lower section of the shaft tube and including a longitudinal hole extending along a longitudinal axis of the bearing;
a shaft including an annular groove in a neck shape formed in an outer periphery of the shaft to form a neck of the shaft, with one end of the shaft extending through the longitudinal hole of the bearing and the annular groove being adjacent to the other end of the shaft, with the neck of the shaft having an outer diameter smaller than that of two sections of the shaft, with said two sections being adjacent to two end edges of the annular groove; and
a leakproof plate being fixed in the upper section of the shaft tube and including a through-hole with a diameter smaller than the outer diameters of the two sections of the shaft, wherein an inner edge of the leakproof plate is in the annular groove, the leakproof plate has a flange forming on an outer edge thereof, and the flange extends along the longitudinal axis of the bearing and upwards to the open end of the center hole.

2. The leakproof structure of shaft tube as defined in claim 1, wherein the shaft tube further includes a shoulder forming in an inner periphery of the center hole and between the upper section and the lower section.

3. The leakproof structure of shaft tube as defined in claim 2, wherein a position of top of the bearing is at the same level as or lower than that of the shoulder.

4. The leakproof structure of shaft tube as defined in claim 2, wherein the leakproof plate abuts against the shoulder.

5. The leakproof structure of shaft tube as defined in claim 1, wherein the leakproof plate forms a plurality of slits extending radially and outwards from an inner edge of the leakproof plate.

6. The leakproof structure of shaft tube as defined in claim 1, wherein the through-hole of the leakproof plate has a diameter larger than the outer diameter of the neck of the shaft.
